(19) United States
(12) Patent Application Publication
(10) Pub. No.: US 2004/0256047 A1
(43) Pub. Date: Dec. 23, 2004

(54) Method for correcting surface shape

(76) Inventor: Yoshiyuki Sekine, Tochigi (JP)

Correspondence Address: MORGAN & FINNEGAN, L.L.P., 3 WORLD FINANCIAL CENTER, NEW YORK, NY, 10281-2101, US

(21) Appl. No.: 10/870,277

(22) Filed: Jun. 17, 2004

(30) Foreign Application Priority Data
Jun. 19, 2003 (JP) 2003-174852

(51) Int. Cl. B32B 31/00; B32B 35/00; G02B 5/08; G02B 7/182

(52) U.S. Cl. 156/94; 359/846

(57) ABSTRACT

A method for correcting a surface shape includes the steps of scraping a multilayer film formed on the substrate's surface of an optical element, and correcting the surface shape of the optical element by detecting the amount of scraping.

This application claims priority benefit under 35 U.S.C. § 119 based on Japanese Patent Application No. 2003-174852 filed on Jun. 19, 2003, which is hereby incorporated by reference herein in its entirety as if fully set forth herein.

### BACKGROUND OF THE INVENTION

The present invention generally relates to a method for correcting a surface shape of a substrate of an optical element on which a multilayer film is formed, and more particularly to a method for correcting a surface shape of a catoptric element used in an optical system whose sight source is, for example, a EUV light or an F2 laser. More concretely, the present invention relates to a method for correcting a surface shape which is applicable to mirrors used in the optical system of exposure apparatuses that fabricate semiconductor devices such as ICs or LSIs, imaging devices such as CCDs, display devices such as liquid crystal panels, or detecting devices such as magnetic heads, by projecting circuit patterns onto wafers as photosensitive substrates.

Along with recent demands for finer semiconductor devices, using EUV light (Extreme Ultraviolet light) in exposure (hereinafter, EUV method) has been proposed as an exposure method in the future generation for semiconductor fabricating apparatus (exposure apparatus). The EUV method exposes and transfers a circuit pattern image that is on a reticle (mask) as an original, onto a wafer as a photosensitive substrate, by using, for example, a light with a short wavelength of 13.4 nm (EUV light) that is 1/10 the length or shorter of a wavelength conventionally used in exposure and in a catoptoric optical system. The transmission property of the light in an optical element remarkably decreases in a EUV method, because the wavelength of EUV light is extremely short. Therefore, the EUV method generally uses a catoptric optical system using mirrors and a reflection-type reticle instead of a refraction optical system that is difficult to use.

However, few materials have enough reflective property in the wavelength range of EUV light. So, a multilayer film having a reflectance-increasing effect will be formed on the surface of the mirror to improve reflectance. It is known that the Mo/Si multi-layer film has this effect. Laminating a plurality of Mo (molybdenum) layers and Si (silicon) layers alternatively forms a Mo/Si multi-layer film. For example, 40 to 50 pairs of layers, wherein each layer has a thickness of 7 nm as approximately half of a EUV light's wavelength of 13.4 nm form the Mo/Si multilayer film. As EUV lights reflected on each layer's boundary interfere with each other during the same phase, the Mo/Si multilayer film formed on the mirror's surface can obtain a high reflectance.

However, since the reflectance of the mirror to EUV light is approximately 70%, despite forming the Mo/Si multilayer film on the surface, the light intensity will decrease cumulatively if an optical system arranges a plurality of mirrors. Therefore, it is preferable to form the optical system with fewer mirrors, and the optical system should satisfy the necessary imaging optical property with fewer mirrors.

Recently, an experimental unit of an exposure apparatus that uses a EUV light source, uses an optical system that has three or four mirrors and has a numerical aperture NA of approximately 0.10, while, optical systems in the future are targeting to have six mirrors and a numerical aperture NA of approximately 0.25 to 0.30. To achieve the high performance of an optical system like this with fewer mirrors, it is important to process and measure the mirror's surface accurately so as to have an accurate surface shape.

The shorter the wavelength of a light source, the more accurate the surface shape of an optical element such as a mirror should be. For example, using Strehl intensity i(P) (the peak value of the relative intensity when the maximum intensity of the spot image in the aplanatic optical system is supposed to be “1”) as a parameter for estimating the optical property, M. Born and E. Wolf disclose an equation (24) in “Principles of Optics: Electromagnetic Theory of Propagation, Interference, and Diffraction of Light, 6^{th} ed. New York: Pergamon Press, p.464. 1989, by M. Born and E. Wolf” as,

$$i ( P ) \approx 1 - {( \frac{2 π}{λ} )}^{2} {( Δ {Φ}_{P} )}^{2} = 1 - {( 2 π )}^{2} {( \frac{Δ {Φ}_{P}}{λ} )}^{2}$$

Here, i(P) is Strehl intensity, ΔΦ_{P} is rms value of wave aberration, ΔΦ_{P}/λ is rms value of wave aberration per wavelength.

The rms values of the wave aberration per wavelength (Δφ_{P}/λ) of two optical systems used in different wavelengths each should be equal so that the Strehl intensities of the two optical systems are equal. However, equalizing the Strehl intensities of those optical systems should be accurate and will be difficult with shorter wavelengths, as clearly described in the above equation.

Moreover, the surface shapes of the mirrors used in the catoptric optical system need higher accuracy than that of the lenses used in the refraction optical system. That is, the dispersion of the surface shape in the mirror that reflects light influences the optical path length twice as much as that in the lens through which the light passes. Additionally, the dispersion of the surface shape in the mirror influences the phase of the light, i.e. the wave aberration, approximately four times as much as that in the lens, because the mirror influences the phase of the light in accordance with the refraction index of atmospheric substance such as air (generally approximately 1.0) while the lens influences the phase of the light in accordance with the difference between the refraction index of the atmosphere and that of the lens substrate (generally approximately 0.5).

Accordingly, tolerance of the dispersion in the mirror's surface shape used in a EUV projection optical system which arranges the catoptric optical system by using a EUV light as the light source is regarded as having a 0.1 nm in rms value. This value is difficult to achieve even with recent processing and measurement technology.

The following is one proposal to counter the situation explained previously. For example, Reference 1 discloses a method for correcting the shape of the mirror by applying a shape correction film formed by a material whose refraction index is close to the atmosphere's refraction index on the surface of the mirror, and processing the shape correction film (see Reference 1). As the difference of the refraction index between the shape correction film and the atmosphere is small, finer processing is not necessary for the phase correction, while, the light absorption by the shape correction film may be a problem in the range of the EUV light's wavelength.

Another proposal discloses a method for scraping the film to improve reflection property (see Reference 2). Reference 2 discloses that scraping the Mo layer film causes a phase shift and can correct the mirror's surface shape as a result, since the refraction index of Mo in the Mo/Si multilayer film is 0.93 and is different from the refraction index of the vacuumed atmosphere (i.e. the refraction index is 1).

FIG. 9 is an explanatory view of an example of a conventional method for the correction of a surface shape. FIG. 9 shows how the reflectance of the mirror and the phase of the reflection light change in accordance with the scraping of the multilayer film formed on the SiO₂ substrate, which has 45 pairs of laminated 2.8 nm thick Mo films and 4.2 nm thick Si films, when the light of 13.4 nm wavelength irradiates the mirror surface perpendicularly. The refraction indexes of each material are cited from open contents in the Internet (see Reference 3). As shown in FIG. 9, the scraping of the Si film barely shifts the phase of the reflection light, for the refraction index of the Si film is approximately 1.0. By using this behavior, a method for correcting the surface shape disclosed in Reference 2 achieves an accuracy to the order of 0.1 nm by scraping the Mo film in accordance with the process latitude of the Si film thickness. Since the phase shift depends on the scraped thickness of the Mo layer but barely depends on the scraped thickness of the Si layer, approximately constant phase can be obtained as far as the surface is the Si layer despite of the thickness of the surface Si layer. The method of scraping a part of the multilayer film can correct the surface shape a little. However, this method is preferable in view of mere influence to the reflectance.

Reference 1: U.S. Pat. No. 5,757,017

Reference 2: “Nuclear Instruments and Methods in Physics Research A, Vol. 467-468, p.1282-1285”, by M. Yamamoto, published ELSEVIER Inc. in 2001, URL:http://www.elsevier.com/

Reference 3: “Center for X-Ray Optics”, disclosed on the Internet URL:http://www-cxro.lbl.gov/ on Mar. 28, 2003

Though both methods disclosed in the above References can reduce the accuracy prescribed to the correction process of the mirror surface, they should measure the amount of correction necessary for the process. However, the References disclose neither the method for processing the shape correction film or the multi-layer film for improving the reflectance, nor the method for measuring the amount of correction (the amount of scraping or lamination) that is necessary in processing.

Conventional methods such as the ion beam etching method or magnetron spattering method are applicable to the process for scraping or lamination. It is important to measure the amount of scraping in the method for scraping the multilayer film in the following way. That is, this method generally corrects the light phase stepwise by eliminating the Mo film and leaving the Si film on surface. As shown in FIG. 9, stopping scraping in the state of leaving the Mo film on the surface and using the phase changing character of the reflection light at an intermediate portion of Mo film can correct the surface shape more accurately. Because the reflectance is at a maximum near the middle of the Mo film and changes according to the thickness of the Si film, it is necessary to detect the amount of scraping accurately, and to scrape the film according to the detection so as to obtain a higher reflectance. Thus, it is important to measure the amount of scraping or lamination in the order of a sub micron, that is, sufficiently smaller than the thickness of the film.

### BRIEF SUMMARY OF THE INVENTION

Accordingly, it is an exemplary object to provide a method for correcting a surface shape of the optical element's (for example, mirror's or reticle's) substrate accurately, improve the optical property of the optical system which uses the optical element, and improve the optical property of the optical apparatus, such as an exposure apparatus which uses the optical system.

In order to achieve the above object, a method for correcting a surface shape according to one aspect of the present invention includes the steps of scraping a multilayer film formed on a substrate's surface of an optical element, and correcting the surface shape of the optical element by detecting an amount of scraping.

A method for correcting a surface shape according to another aspect of the present invention includes the steps of laminating a correction film on a substrate's surface of an optical element on which a multi-layer film is formed, and correcting the surface shape of the optical element by detecting the amount of lamination.

In the method for correcting the surface shape, the optical element may be a mirror. The multilayer film may have a periodic lamination of at lease two different layers to improve reflectance of the optical element to a light of a specific wavelength. The method for correcting the surface shape may further include the step of detecting the amount of scraping or the amount of lamination by measuring the reflectance of the optical element compared to a light of a wavelength different from the specific wavelength. The method for correcting the surface shape may further include the step of counting increase and decrease repetitions of the reflectance of the optical element compared to the light of the wavelength different from the specific wavelength, the repetition being caused by the scraping of the multilayer film or the lamination of the correction film. The method for correcting the surface shape may further include the step of detecting the amount of scraping or the amount of lamination by measuring the phase of the light of the wavelength different from the specific wavelength. The method for correcting the surface shape may further include the step of detecting the amount of scraping in accordance with the time necessary for scraping and an amount of scraping per unit of time by estimating in advance the amount of scraping per unit of time for each layer which forms the multilayer film. The method for correcting the surface shape may further include the step of detecting the amount of scraping by specifying a material which forms a surface layer of the multi-layer film in accordance with a fluorescent X-ray scattered from the surface layer of the multilayer film irradiated by X-rays; the multi-layer film being laminated with at least two different materials. The method for correcting the surface shape may further include the step of detecting the amount of scraping by analyzing the mass of a surface material of the multilayer film laminated with at least two different materials.

A method for correcting the surface shape according to still another aspect of the present invention includes the steps of scraping a multilayer film formed on a substrate's surface of an optical element, detecting an amount of scraping, and correcting the surface shape of the optical element.

A method for measuring the surface shape according to still another aspect of the present invention includes the steps of measuring the surface shape of an optical element by detecting the amount scraped from a multi-layer film formed on a surface of the substrate of the optical element to improve the reflectance of the optical element for a light of a specific wavelength, said multilayer film is periodically laminated with at least two different layers, and detecting the amount of scraping by measuring a reflectance of the optical element to a light of a wavelength different from the specific wavelength.

A mirror, according to still another aspect of the present invention, includes a surface shape that is corrected by using a method for correcting the surface shape as previously explained.

A projection optical system according to still another aspect of the present invention includes an optical element whose surface shape is corrected by using a method for correcting the surface shape as previously explained.

An exposure apparatus which projects a pattern of a reticle onto an object according to still another aspect of the present invention includes an illumination optical system for illuminating the reticle with a light from a light source, and a projection optical system that includes an optical element whose surface shape is corrected by using a method for correcting the surface shape including the steps of scraping a multilayer film formed on a surface of the substrate of the optical element, and correcting the surface shape of the optical element by detecting the amount of scraping.

A device fabricating method according to still another aspect of the present invention includes the steps of exposing an object by using an exposure apparatus which projects a pattern of a reticle onto an object, an exposure apparatus that includes an illumination optical system for illuminating the reticle with a light from a light source, and a projection optical system that includes an optical element whose surface shape is corrected by using a method for correcting the surface shape that includes the steps of scraping a multilayer film formed on a surface of the substrate of the optical element, and correcting the surface shape of the optical element by detecting the amount of scraping, and developing the object that has been exposed.

Other objects and further features of the present invention will become readily apparent from the following description of the preferred embodiments with reference to the accompanying drawings.

### BRIEF DESCRIPTION OF THE DRAWINGS

FIG. 1 is an explanatory view of a method for correcting a surface shape of the first and second embodiments according to the present invention, showing the relation obtained by calculation of the amount of scraping of a multilayer film formed on a substrate surface of a mirror, versus the reflectance of the mirror and a phase of a reflection light corresponding to the amount of scraping.

FIG. 2 is a schematic view of an example of an apparatus that uses a method for correcting the surface shape of the first embodiment according to the present invention.

FIG. 3 is a schematic view of an example of an apparatus that uses a method for correcting the surface shape of the second embodiment according to the present invention.

FIG. 4 is a schematic view of an example of an apparatus that uses a method for correcting the surface shape of the third embodiment according to the present invention.

FIG. 5 is a schematic view of an example of an apparatus that uses a method for correcting the surface shape of the fourth embodiment according to the present invention.

FIG. 6 is a schematic view of an exposure apparatus of the fifth embodiment according to the present invention.

FIG. 7 is a flowchart for explaining a method for fabricating devices that have an exposure process by an exposure apparatus that has a projection optical system using a mirror whose surface shape has been corrected by a method described in the first embodiment of the present invention.

FIG. 8 is a detailed flowchart of step 104 shown in FIG. 7.

FIG. 9 is an explanatory view of an example of a conventional method for the correction of the surface shape, which shows how the reflectance of the mirror and the phase of the reflection light change in accordance with the scraping of the multilayer film that has 45 pairs of laminated 2.8 nm thick Mo films and 4.2 nm thick Si films on the SiO₂ substrate, when the light of 13.4 nm wavelength irradiates the mirror surface perpendicularly.

### DETAILED DESCRIPTION OF THE PREFERRED EMBODIMENTS

This invention relates to a method for correcting the surface shape of a substrate by laminating a correction film for correcting the surface shape of the substrate or scraping a multilayer for improving the reflectance, and to a method for correcting the surface shape by detecting the amount of lamination or scraping as a correction value. The detection of the correction value is preferable but not limited to progress simultaneously with the process of surface shape correction (i.e., lamination process or scraping process). The correction value may be detected after stopping the process of the surface shape correction and the process may restart after finishing the detection. Though the following is an example that describes the scraping of the multilayer film, the present invention is applicable to the correction by laminating the correction film onto the multilayer film, except in case of the fourth embodiment, which will be explained later.

### The First Embodiment

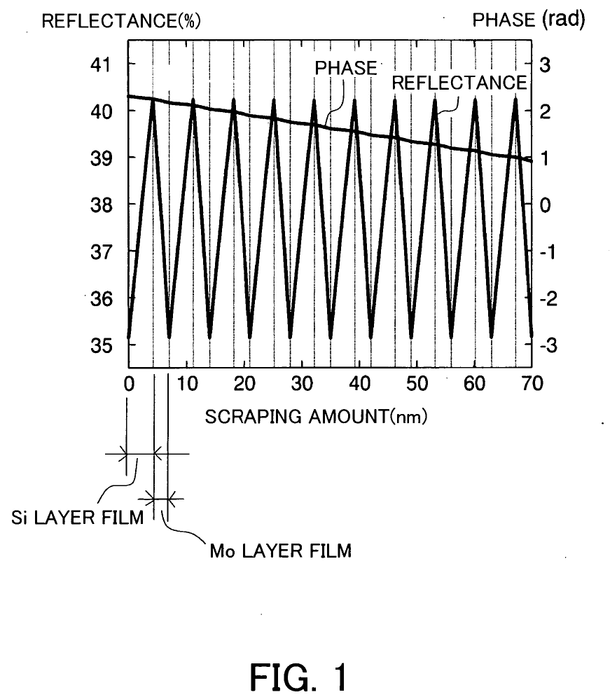

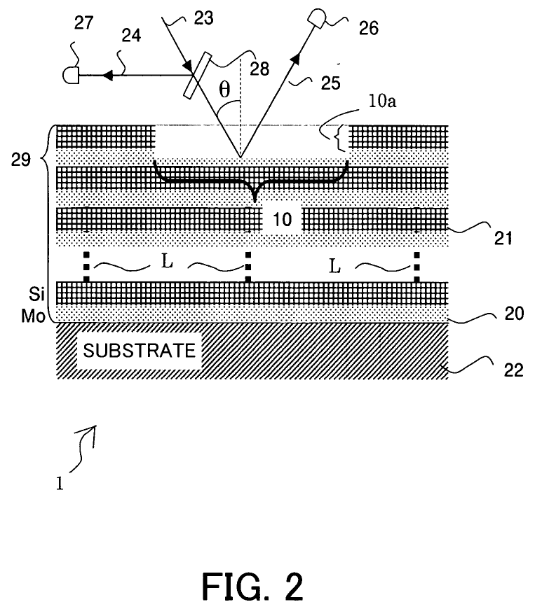

Now a description will be given of a method for correcting the surface shape of the first embodiment according to the present invention referred to in the accompanying drawings. FIG. 1 is an explanatory view of a method for correcting the surface shape of the first and second embodiments (explained later) according to the present invention. FIG. 1 shows the relationship obtained by calculation of the amount of scraping of a multilayer film 29 formed on a substrate 22 surface of a mirror 1, versus the reflectance of a mirror 1 and the phase of a reflection light corresponding to the amount of scraping (see also FIG. 2). A catoptric optical system in an exposure apparatus that uses a EUV light with a 13.4 nm wavelength as a light source uses the mirror 1 as a catoptric optical element.

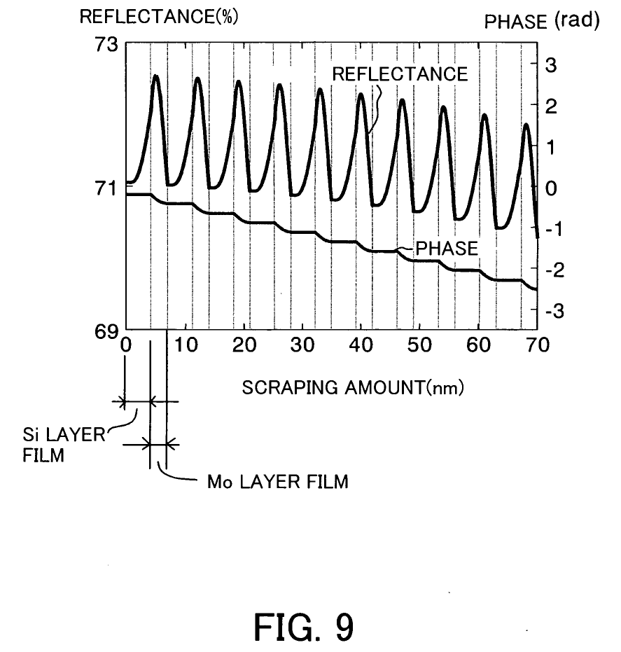

A multilayer film 29 formed on the SiO₂ substrate shown in FIG. 2 has 45 pairs of laminated 2.8 nm thick Mo films 20 and 4.2 nm thick Si films that are the same as those shown in FIG. 9. The multilayer film 29 improves the reflectance of a light of specific wavelength, for example, a EUV light with a 13.4 nm wavelength. FIG. 1 shows a reflectance and a phase of the reflection light of the mirror 1 when a light 23 of a wavelength (for example, a He—Ne laser beam with a 632.8 nm wavelength which is called as “measurement light” hereinafter) that is different from the specific wavelength previously explained, enters into the mirror 1 perpendicularly. The values of the refraction indexes of the Mo layer 20, the Si layer 21, and the SiO₂ substrate 22 to the incident light (measurement light) 23 are cited from “HANDBOOK OF OPTICAL CONSTANTS OF SOLIDS” edited by E. D. Palik, published by Academic Press Inc. in 1985. The dotted vertical lines in FIG. 1 show the alternate periodic lamination of the Mo layer 20 and the Si layer 21.

The first embodiment measures the reflectance of the mirror 1 by using the He—Ne laser with a 632.8 nm wavelength as the measurement light 23. As shown in FIG. 1, the increase of the scraping amount of the Si layer 21 improves the reflectance of the mirror 1, and the increase of the scraping amount of the Mo layer 20 lowers the reflectance of the mirror 1. As the increase and decrease of the mirror 1's reflectance corresponds to the scraping amount of each layer 20 and 21, using this behavior, the scraping amount of the multilayer film 29 can be known by processing and correcting the surface shape of the mirror 1 by detecting the reflectance of the mirror 1.

As shown in FIG. 1, the amplitude of the change of the reflectance is approximately 5%, and the reflection light 25 can be measured with ease because the measurement light 23 is the He—Ne laser beam whose wavelength is easy to be measured. Since the reflectance of the mirror 1 is not so high for the wavelength of the He—Ne laser beam and the reflectance of the Mo/Si multilayer film 29 peaks in the vicinity of a 240 nm wavelength, the measurement light 23 can use ultraviolet light such as the second harmonic of an Ar laser or an Nd:YAG laser. When the measurement light 23 uses the infrared light, the amplitude of the reflectance change can be expected to be larger because the absorption coefficient of the Mo layer 20 is much different from that of the Si layer 21.

As the multilayer film 29 has the periodic structure that is alternately laminated by the Mo layer 20 and the Si layer 21, the reflectance changes periodically. Therefore, the reflectance of the mirror 1 does not have a one-to-one corresponding relationship to the scraping amount of the multilayer film 29. In this case, the absolute value of the scraping amount can be known by counting how many times the mirror 1's reflectance increases and decreases corresponding to one cycle repeat in accordance with the scraping. Thus the present invention can determine the shape correction value of the mirror 1's surface by measuring the reflectance of the reflection light 25 from the mirror 1 by using the structure of the multi-layer film 29 formed on the surface in spite of measuring the scraping amount as a thickness of the multi-layer film 29 directly.

Meanwhile, the example shown in FIG. 9 that uses the light of the 13.4 nm wavelength as a measurement light has approximately 1.5% amplitude of the reflectance change, and it is thought to be able to detect the scraping amount by using the amplitude of the reflectance change. However, multiple interferences complicate the relationship of the scraping amount's change to the reflectance change. Therefore, to use the 13.4 nm wavelength light as the measurement light is not realistic in the sense that relating the layer boundary between the Mo layer and the Si layer to the reflectance change is difficult, and measuring the reflectance using the measurement light with a 13.4 nm wavelength is not easy, particularly in the condition of “correcting the surface shape by measuring the reflectance (in situ)”.

FIG. 2 is a schematic view of an example of an apparatus that uses a method for correcting the surface shape of the first embodiment according to the present invention. A substrate 22 of the mirror 1 uses, for example, quartz (SiO₂), and the calculation of the reflectance and the phase as shown in FIG. 1 uses physical property values of quartz, such as parameters. However, since the measurement light 23 barely reaches the substrate 22, the substrate is not limited to quartz and can use other materials. The substrate of the mirror used for EUV light with a 13.4 nm wavelength generally uses low expansion glass to reduce the influence of thermal expansion caused by light absorption at the mirror surface. The multilayer film 29 is scraped at a scraping area 10 of the multilayer film 29 to correct the surface shape of the mirror 1. The measurement light 23 is emitted to the scraping area 10 and an intensity measurement apparatus 26 for the reflection light measures the reflection light 25 so as to detect the scraping amount 10a.

The He—Ne laser (not shown), with a wavelength of 632.8 nm, acts as the light source and emits the measurement light 23; a part of the measurement light 23 irradiates the scraping area 10 of the multi-layer film 29 on the substrate's surface with the incident angle of θ through a separation mirror 28 whose reflectance Rm is known in advance. The rest of the measurement light 23 is reflected by the separation mirror 28, reaches an intensity measurement apparatus 27 for monitoring as a monitor light 24, and a monitor light intensity Ia is measured so as to monitor the stability of the measurement light 23's intensity. The measurement light 23 that passes through the separation mirror 28 is reflected on the scraping area 10, reaches the intensity measurement apparatus 26 for the reflection light as the reflection light 25, and a reflection light intensity Ib is measured. The reflectance R of the multilayer film 29 is calculated by the equation R=Rm×Ib/Ia. By measuring the reflectance R by scraping the multilayer film 29, the scraping amount 10a corresponding to the reflectance R can be detected.

Now a description of the method for correcting the surface shape will be given.

The surface shape of the mirror 1 is corrected by a processing means that is not shown. The multilayer film 29 formed on the substrate 22's surface is partially scraped by measuring the scraping amount 10a at the scraping area. In measuring the scraping amount 10a, the measurement light 23 emitted from the He—Ne laser (not shown) enters into the scraping area 10 via the separation mirror 28 with the incident angle of θ. The intensity Ia of the monitor light 24 reflected by the separation mirror 28 is measured by the intensity measurement apparatus 27 for monitoring, and the intensity Ib of the reflection light 25 reflected on the scraping area 10 after passing through the separation mirror 28 is measured by the intensity measurement apparatus 26 for the reflection light.

The reflectance R of the multi-layer film 29 at the scraping area 10 is calculated by using the reflectance Rm of the separation mirror by the equation of R=Rm×Ib/Ia. As shown in FIG. 1, the increasing and decreasing states of the reflectance R reverse at the boundary of the Mo layer 20 and the Si layer 21 in accordance with the scraping amount 10a, and show a periodic wavy shape that repeats the increase and decrease in the reflectance's range of approximately 35% to 40%. Therefore, counting the number of repetitions by measuring the reflectance R can detect the scraping amount 10a. Emitting the measurement light to the surface of the multilayer film 29 that is outside of the scraping area 10 with the same condition and measuring the reflection light from outside of the scraping area 10 in addition to the measurement previously explained can calibrate the measurement result of the intensity measurement apparatus 26 for the reflection light.

As explained before, the first embodiment can correct the surface shape of the mirror 1's substrate 22 accurately by scraping the surface of the mirror 1 (i.e., correcting the surface of the mirror 1 by processing) by detecting the scraping amount 10a by measuring the reflectance of the reflection light at the scraping area 10.

### The Second Embodiment

Now a description will be given of a method for correcting the surface shape of the second embodiment according to the present invention. The second embodiment uses the difference between the phase shift of the light of a wavelength and the specific wavelength to improves reflectance. As shown in FIG. 1, the scraping amount and the phase of the reflection light are approximately linear in relation in spite of the small fluctuation caused by the difference between the reflectance of the Mo layer 20 and that of the Si layer 21. The measurement of the phase of the reflection light can detect the scraping amount because of an approximately one-to-one corresponding relationship of the scraping amount to the phase of the reflection light.

In FIG. 1, the reflectance of the reflection light changes periodically in accordance with the increase of the scraping amount, while the phase of the reflection light does not change periodically but rather, approximately linearly. Therefore, the scraping amount can be detected by measuring only the phase shift based on the phase of the scraping amount being equal to zero in the range of the phase shift being in ±2π (radian). The first embodiment needs to count the number of repetitions of the increase and decrease of the reflectance of the reflection light, while the second embodiment does not. Since ten pairs of the Mo layer 20 and the Si layer 21 scraping of multi-layer film 29 cause the phase shift of approximately 1.5 radian, the measurement range according to ±2π (radian) will be large enough.

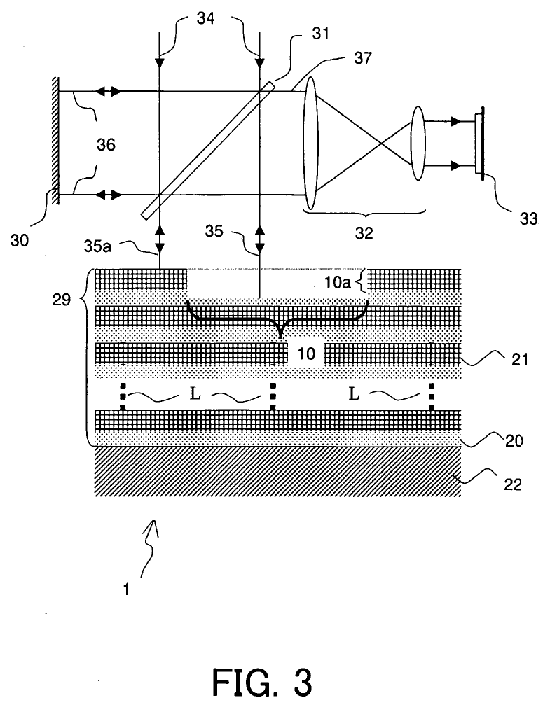

FIG. 3 is a schematic view of an example of an apparatus that uses a method for correcting the surface shape of the second embodiment according to the present invention. The multilayer film 29 is formed on the substrate 22 in the same way as shown in FIG. 2. A measurement light 34 emitted from the He—Ne laser with a 632.8 nm wavelength which is the light of a wavelength different from the specific wavelength (not shown) is deformed to the parallel light by a collimator lens (not shown), and enters into a half mirror 31. The measurement light is separated to a reference light 36 that is reflected by the half mirror 31, reaches a reference plane 30, and is reflected on the reference plane 30, and a reflection light 35 that passes through the half mirror 31, irradiates the scraping area 10 perpendicularly, and is reflected on the scraping area 10.

The reference light 36 passes through the half mirror 31, the reflection light 35 is reflected by the half mirror 35, both lights are composed as an object light 37, and the object light 37 is guided to an optical system 32 and reaches to an imaging device 33, such as a CCD. In observation of the object light 37 by the imaging device 33, an interference fringe caused by the composition of the reference light 36 and the reflection light 35 is observed. Measuring the interference fringe by a known measurement means such as an interferometer can measure the phase of the object light 37, and the scraping amount 10a can be detected in accordance with the phase of the object light 37.

By irradiating the multilayer film 29's surface outside of the scraping area 10 with the measurement light 34 and measuring the phase of the light composed with a reflection light 35a and the reference light 36 in addition to above explained measurement, the difference between the phase of the object light 37 from the scraping area 10 and that of the light from outside of the scraping area 10 can be detected. Measuring the phase shift (i.e., the change of the phase) of these two lights can detect the absolute value of the scraping amount 10a, because the phase shift corresponds to the absolute value of the scraping amount 10a.

The surface shape of the mirror 1's substrate 22 can be corrected accurately by correcting the surface shape of the mirror 1 by detecting the scraping amount 10a, as explained before. Moreover, the method for correcting the surface shape according to the second embodiment can be applied in a situation where a single layer of film (not the multilayer film 29) or no film is formed on the surface of the substrate 22, because the scraping amount 10a is detected in accordance with the difference between the optical path of the reflection light from the scraping area 10 and that of the light from outside of the scraping area 10.

### The Third Embodiment

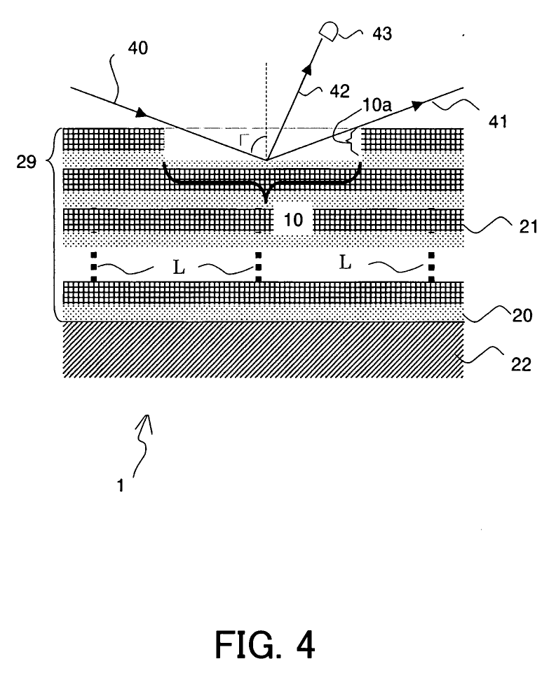

FIG. 4 is a schematic view of an example of an apparatus that uses a method for correcting the surface shape of the third embodiment according to the present invention. The third embodiment irradiates the scraping area 10 of the multilayer film 29 formed on the surface of the substrate 22 by an incident X-ray 40 emitted from an X-ray source (not shown).

If the incident X-ray 40 irradiates the scraping area 10, a fluorescent X-ray 42 whose wavelength is peculiar to the surface material will be scattered in addition to a reflection X-ray 41. Measuring the wavelength of the fluorescent X-ray 42 by the wavelength measurement apparatus 43 can specify the surface material of the scraping area 10. For example, the third embodiment can detect whether the surface layer of the scraping area 10 is the Mo layer 20 or the Si layer 21 by measuring the wavelength of the fluorescent X-ray 42. By specifying the material on the surface layer of the multilayer film 29, the scraping amount 10a can be detected in accordance with the result of the specification. The third embodiment can hardly detect the scraping amount 10a accurately because the scraping amount 10a is detected by the specification of the surface material. Therefore, to detect the scraping amount 10a accurately, it is preferable to use the method of the third embodiment combined with the method of the first or the second embodiment.

To measure the wavelength of the fluorescent X-ray 42 from the multi-layer film 29 of several nm orders in the third embodiment, an incident angle of the incident X-ray 40 is preferably 90°. Because the incident X-ray 40 with a small incident angle reaches deeply through the multilayer film 29, it will be difficult to measure the surface material. If the penetration depth of the multi-layer film 29 of the incident X-ray 40 is near 1 nm, it is difficult to detect the scraping amount 10a in the beginning of scraping each layer (the Mo layer 20 or the Si layer 21) because of the penetration depth being remarkably small in comparison with the layer thickness of the multilayer film 29. Therefore, the incident angle is preferably decided so that the incident X-ray 40 penetrates approximately 2 to 3 layers of the multilayer film 29.

### The Fourth Embodiment

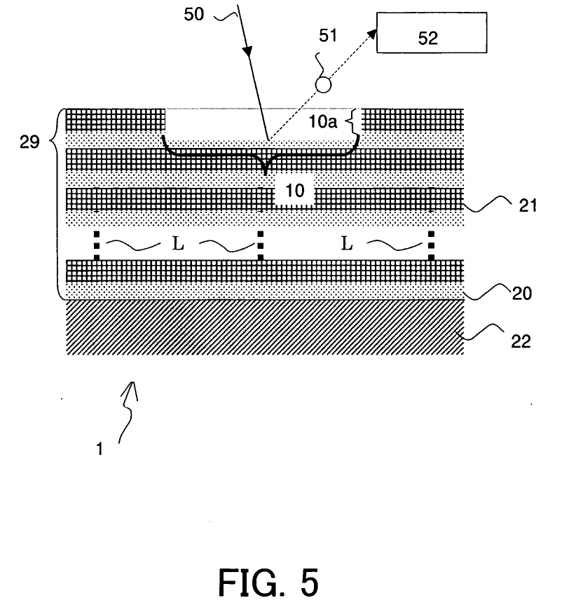

FIG. 5 is a schematic view of an example of an apparatus that uses a method for correcting the surface shape of the fourth embodiment according to the present invention. The fourth embodiment scrapes the scraping area 10 by using an ion beam 50, and corrects the surface shape of the mirror 1. A surface material 51 of the scraping area 10 is eliminated by the ion beam 50, and scatters in the atmosphere. By analyzing the mass of the scattered material 51 by guiding the material 51 to a mass analyzer 52 via an intake (not shown), the material 51 at the surface of the scraping area 10 can be specified.

The atomic weight of Mo is 95.94, and that of Si is 28.09, in the Mo/Si multilayer film 29. Therefore, by measuring the atomic weight of the material 51, the surface material can be specified whether it is Mo or Si. By specifying the material of the surface layer of the multilayer film 29, the scraping amount 10a can be detected in accordance with the result of the specification. The fourth embodiment can hardly detect the scraping amount 10a accurately because the scraping amount 10a is detected by the specification of the surface material. Therefore, to detect the scraping amount 10a accurately, it is preferable to use the method of the third embodiment combined with the method of the first or the second embodiment. For example, it is preferable to apply the mass analysis according to the fourth embodiment to the method for correcting the surface shape that measures the necessary time for scraping each layer (the Mo layer 20 and the Si layer 21) and calculates the scraping amount of each layer (20 and 21) per unit time in advance, and detects the scraping amount in accordance with measured process time, because it does not need other specific measurement apparatus.

Moreover, the methods for correcting the surface shape or the methods for detecting the scraping amount according to the first to fourth embodiments can be used in combination with each other. By combining these methods according to the kind of the correction method or situation, the accuracy of the detection will be further improved and the correction of the surface shape will be stable.

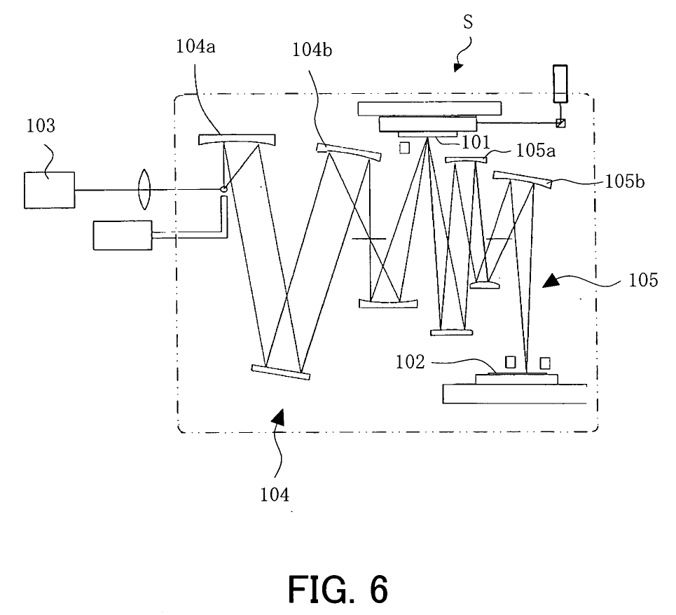

FIG. 6 is a schematic view of an exposure apparatus S of the fifth embodiment according to the present invention. The exposure apparatus S exposes a circuit pattern on a reticle 101 that serves as an original form onto a wafer 102 that serves as an object. For example, the exposure apparatus includes an illumination optical system 104 for guiding the light from the EUV light source 103 onto the reticle 101, and a projection optical system 105 for projecting the circuit pattern image of the reticle 101 onto the wafer 102.

The illumination optical system 104 has mirrors 104a and 104b that serve as optical elements. The projection optical system also has mirrors 105a and 105b that serve as optical elements. The surface shape of the mirrors 104a, 104b, 105a, and 105b are corrected by using the methods for correcting the surface shape according to the first to fourth embodiments. Therefore, the reflectance and the optical property of the mirror are improved, and the exposure apparatus S can expose with high accuracy.

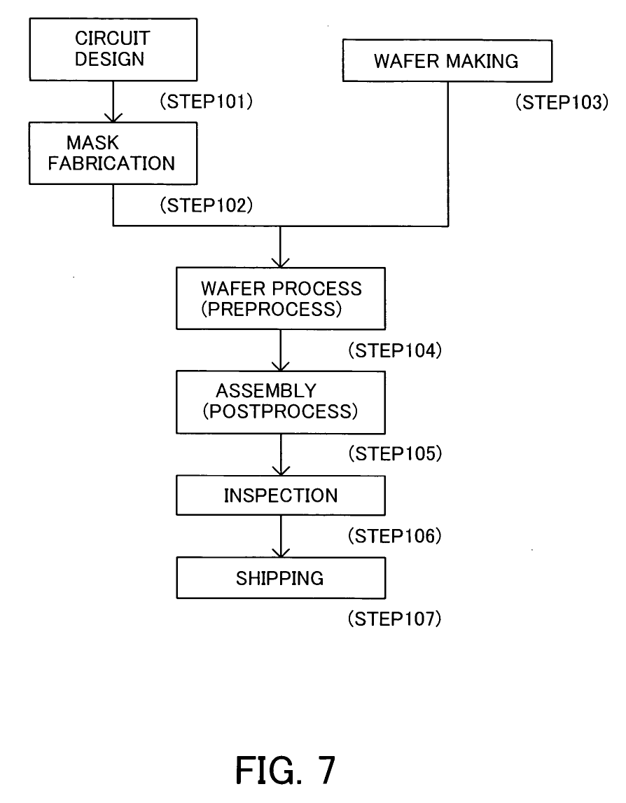

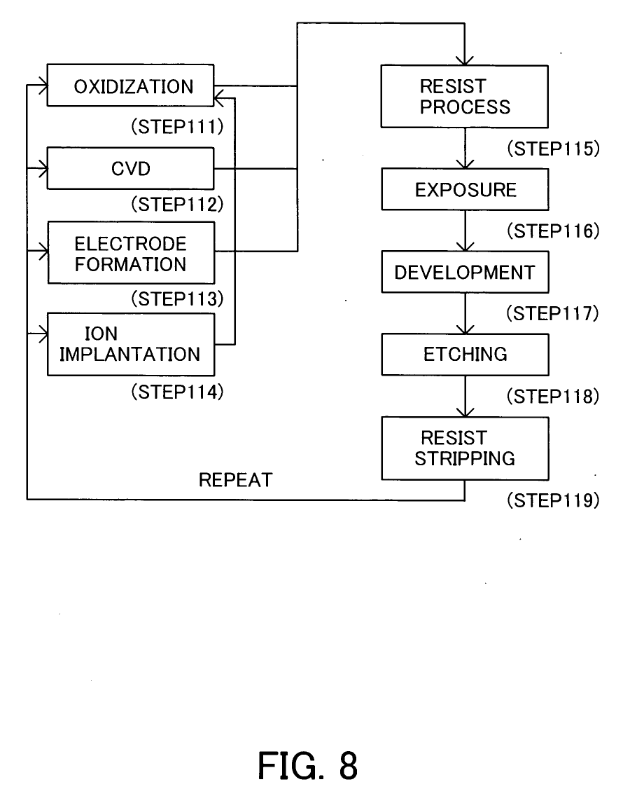

Referring now to FIGS. 7 and 8, a description will be given of an embodiment of a device fabricating method using the above exposure apparatus S. FIG. 7 is a flowchart explaining the fabrication of devices (i.e., semiconductor chips such as IC and LSI, LCDs, CCDs, etc.). Here, as an example, a description will be given of semiconductor chip fabrication. Step 101 (circuit design) designs a semiconductor device circuit. Step 102 (mask fabrication) forms a mask having a designed circuit pattern. Step 103 (wafer preparation) manufactures a wafer using materials such as silicon. Step 104 (wafer process), referred to as a pretreatment, uses the mask and wafer to form the actual circuitry on the wafer through photolithography. Step 105 (assembly), also referred to as a posttreatment, forms the wafer from Step 104 into a semiconductor chip and includes an assembly step (e.g., dicing, bonding), a packaging step (chip sealing), and the like. Step 106 (inspection) performs various tests on the semiconductor device made in Step 105, such as a validity test and a durability test. Through these steps, a semiconductor device is finished and shipped (Step 107).

FIG. 8 is a detailed flowchart of the wafer process in Step 104. Step 111 (oxidation) oxidizes the wafer's surface. Step 112 (CVD) forms an insulating film on the wafer's surface. Step 113 (electrode formation) forms electrodes on the wafer by vapor disposition and the like. Step 114 (ion implantation) implants ion into the wafer. Step 115 (resist process) applies a photosensitive material onto the wafer. Step 116 (exposure) uses the exposure apparatus S to expose the circuit pattern on the mask onto the wafer. Step 117 (development) develops the exposed wafer. Step 118 (etching) etches parts other than the developed resist image. Step 119 (resist stripping) removes unused resist after etching. These steps are repeated to form multilayer circuit patterns on the wafer. The device fabrication method of this embodiment may manufacture higher quality devices than the conventional method. Accordingly, the device fabricating method and the devices as products are also within the scope of the present invention.

Further, the present invention is not limited to these preferred embodiments; various variations and modifications may be made without departing from the scope of the present invention.

As explained before, the present invention can detect the shape of the surface of the substrate of the optical element in the order of 0.1 nm, correct the surface shape with higher accuracy, and improve the reflectance of the mirror as the optical element. Therefore, the present invention can improve the optical property of the optical system using the optical element, and the optical property of the optical apparatus such as the exposure apparatus that uses the optical system.

What is claimed is:

1. A method for correcting a surface shape comprising the steps of:
scraping a multi-layer film formed on a substrate's surface of an optical element; and
correcting the surface shape of the optical element by detecting the amount of scraping.

2. A method for correcting a surface shape comprising the steps of:
laminating the correction film on a substrate's surface of an optical element on which a multilayer film is formed; and
correcting the surface shape of the optical element by detecting the amount of lamination.

3. The method for correcting the surface shape according to claim 1, wherein the optical element is a mirror.

4. The method for correcting the surface shape according to claim 1, wherein the multi-layer film has a periodic lamination of at least two different layers to improve the reflectance of the optical element for a light of a specific wavelength.

5. The method for correcting the surface shape according to claim 4, further comprising the step of detecting the amount of scraping by measuring the reflectance of the optical element for a light of a wavelength different from the specific wavelength.

6. The method for correcting the surface shape according to claim 5, further comprising the step of counting the increase and decrease repetitions of the reflectance of the optical element for the light of the wavelength different from the specific wavelength, said repetition being caused by the scraping of the multi-layer film.

7. The method for correcting the surface shape according to claim 4, further comprising the step of detecting the amount of scraping by measuring a phase of the light of the wavelength different from the specific wavelength.

8. The method for correcting the surface shape according to claim 2, wherein the multilayer film has a periodic lamination of at least two different layers to improve the reflectance of the optical element for a light of a specific wavelength.

9. The method for correcting the surface shape according to claim 8, further comprising the step of detecting the amount of lamination by measuring a the reflectance of the optical element for a light of a wavelength different from the specific wavelength.

10. The method for correcting the surface shape according to claim 9, further comprising the step of counting the increase and decrease repetitions of the reflectance of the optical element for the light of the wavelength different from the specific wavelength, said repetition being caused by the lamination of the correction film.

11. The method for correcting the surface shape according to claim 8, further comprising the step of detecting the amount of lamination by measuring a phase of the light of the wavelength different from the specific wavelength.

12. The method for correcting the surface shape according to claim 1, further comprising the step of detecting the amount of scraping in accordance with the time necessary for scraping and an amount of scraping per unit of time by estimating in advance the scraping per unit of time of each layer which forms the multi-layer film.

13. The method for correcting the surface shape according to claim 1, further comprising the step of detecting the amount of scraping by specifying a material which forms the surface layer of the multi-layer film in accordance with a fluorescent X-rays scattered from the surface layer of the multi-layer film irradiated by an X-ray, said multi-layer film being laminated with at least two different materials.

14. The method for correcting the surface shape according to claim 1, further comprising the step of detecting the amount of scraping by analyzing the mass of the surface material of the multi-layer film laminated with at least two different materials.

15. A method for correcting a surface shape comprising the steps of:
scraping a multilayer film formed on a substrate's surface of an optical element,
detecting an amount of scraping; and
correcting the surface shape of the optical element.

16. A method for measuring a surface shape comprising the steps of:
measuring the surface shape of an optical element by detecting an amount scraped from a multilayer film formed on a surface of a substrate of the optical element to improve reflectance for a light of a specific wavelength, said multilayer film being periodically laminated with at least two different layers; and
detecting the amount of scraping by measuring the reflectance of the optical element for a light of a wavelength different from the specific wavelength

17. A mirror comprising a surface shape that is corrected by using a method for correcting the surface shape which includes the steps of scraping a multilayer film formed on a surface of a substrate of an optical element, and correcting the surface shape of the optical element by detecting the amount of scraping.

18. A projection optical system comprising an optical element whose surface shape is corrected by using a method for correcting the surface shape which includes the steps of scraping a multilayer film formed on a surface of a substrate of the optical element, and correcting the surface shape of the optical element by detecting the amount of scraping.

19. An exposure apparatus comprising:
an illumination optical system for illuminating the reticle with a light from a light source; and
a projection optical system for projecting a pattern of the reticle onto an object to be exposed, the projection optical system includes an optical element whose surface shape is corrected by using a method for correcting the surface shape including the steps of scraping a multilayer film formed on the surface of the substrate of an optical element, and correcting the surface shape of the optical element by detecting an amount of scraping.

20. A device fabricating method comprising the steps of:
exposing an object by using an exposure, the exposure apparatus including an illumination optical system for illuminating a reticle with a light from a light source, and a projection optical system for projecting a pattern of the reticle onto the object, the projection optical system includes an optical element whose surface shape is corrected by using a method for correcting the surface shape including the steps of scraping a multilayer film formed on the substrate's surface of an optical element, and correcting the surface shape of the optical element by detecting an amount of scraping; and
developing the object that has been exposed.
